(19) United States
(12) Patent Application Publication
(10) Pub. No.: US 2020/0184016 A1
(43) Pub. Date: Jun. 11, 2020

(54) SEGMENT VECTORS

(71) Applicant: GOVERNMENT OF THE UNITED STATES AS REPRESETNED BY THE SECRETARY OF THE AIR FORCE, ROME, NY (US)

(72) Inventor: COLLEN ROLLER, ROME, NY (US)

(21) Appl. No.: 16/214,245

(22) Filed: Dec. 10, 2018

(51) Int. Cl. G06F 17/27; G06N 3/08

(52) U.S. Cl. CPC G06F 17/2785; G06N 3/08; G06F 17/2715

(57) ABSTRACT

A neural network system includes one or more computers including a memory to store a set of documents having textual elements; and a processor to partition the set of documents into sentences and paragraphs; create a segment vector space model representative of the sentences and paragraphs; identify textual classifiers from the segment vector space models; and utilize the textual classifiers for natural language processing of the set of documents. The processor may partition the set of documents into words and sentences. The processor may create the segment vector space model representative of sentences, paragraphs, and words, and documents.

### GOVERNMENT INTEREST

The invention described herein may be manufactured and used by or for the Government of the United States for all government purposes without the payment of any royalty.

### BACKGROUND

### Field of the Invention

The embodiments herein generally relate to neural networks, and more particularly to techniques for electronically embedding documents for natural language processing.

### Background of the Invention

At its essence, natural language processing (NLP) is defined by the act of understanding and interpreting natural language to yield knowledge. Knowledge extraction plays an essential role in today's society across all domains as the consistent increase of information has challenged even the best computational language capabilities across the globe. Semantic vector space models have shown great promise across a large variety of NLP tasks such as information retrieval (IR), document classification, sentiment analysis, and question and answering systems, to name a few examples. Conventionally, these vector space models are created by using neural embeddings. However, more simplistic architectures such as word2vec and doc2vec have recently become popular due to their ability to produce high-quality vectors with minimal training data. These embeddings are powerful since they can be used as the basis for production level machine learning models.

Generally, doc2vec is a shallow neural network architecture aimed at learning document-level embeddings. Furthermore, doc2vec contains two algorithms: Distributed Memory with Paragraph Vectors (DMPV) and Distributed Bag-of-Words (DBOW). Both algorithms build upon previous methods including Skip-gram and Continuous Bag-of-Words (CBOW) (more commonly known as word2vec). DMPV uses word order during training and is a more complex model than its complement DBOW which ignores word order during training. Originally, DMPV was considered to be an overall stronger model and consistently outperformed DBOW, however, other researchers have shown contradictions to this observation.

In addition to the uncertainty over doc2vec, both DMPV and DBOW have only been evaluated over smaller classification tasks using sentence and paragraph level document samples during training. This spawns questions as to how these methods perform on larger classification using paragraph and document level length segments during training. Particularly, preliminary experiments have shown that DMPV and DBOW suffer from poor performance when facing such tasks.

Conventionally, word2vec was proposed as a shallow and efficient, neural network approach for learning high-quality vectors from large amounts of unstructured text. word2vec contains two approaches Skip-gram and CBOW. Fundamentally, both approaches predict a missing word or words. In CBOW, the model accepts a set of context words as input and infers a missing target word. In Skipgram, the model accepts a target word as input and produces a ranked set of context words. For Skipgram, negative sampling has been introduced to reduce training complexity and has been shown to increase the quality of the word vectors. Hereinafter, when this architecture is described below, it is referred to as Skip-gram Negative Sampling (SGNS).

The objective function of word2vec maximizes the average log probability of log P(w_{C}|w_{I}) where w_{C} is the context word and W_{I} is the input word. By introducing negative sampling, the objective function is modified to maximize the dot product of both w_{C} and W_{I} while minimizing the dot product of W_{I} and randomly sampled words occurring over a training threshold t. More formally, log P(w_{C}|w_{I}) can be represented in Equation (1) as:

log σ((v′_{w}_{_{C}})^{T} v_{w}_{_{I}})+Σᵢ₌₁^{k} wᵢ˜Pₙ(w)[log σ((−v′_{w}_{ᵢ})^{T} v_{w}_{_{I}})] (1)

As indicated above, word2vec was presented in two varying approaches: SGNS and CBOW. In the context of the presented objective function, SGNS uses a single token v_{w}_{_{I}} for input and aims to predict tokens to the left and right of the input token within a context window. Alternatively, CBOW takes an input v_{w}_{_{I}} which includes multiple tokens that are summed to predict a single context token.

Paragraph vectors otherwise known as doc2vec were introduced as an extension to word2vec for learning distributed representations of text segments of variable length (sentences to full documents). Generally, doc2vec uses a similar architecture to word2vec, but instead of using only word vectors as features for predicting the next word in the sentence, the word vectors are used in conjunction with a paragraph level vector for the prediction task. In doing so, doc2vec allows for some semantic information to be used in its prediction. Additionally, doc2vec was presented through two approaches: DMPV and DBOW.

DMPV generally mimics the CBOW architecture as multiple tokens are used as input to predict a single context token. DMPV differs in that a special token representing a document is used in conjunction with multiple word tokens for the prediction task. In addition, the vectors representing each input token are not summed, but concatenated together with the document token before passing to the hierarchical softmax layer of the model.

Similarly, DBOW mimics the method introduced in SGNS by focusing on predicting words within a context window from a single token. However, instead of using a word token as input, the input is replaced by a space token representing a document. There is no sense of word order in this model, as the algorithm focuses on predicting randomly sampled words which motivates the name distributed bag of words.

Additionally, doc2vec uses linear operations on word embeddings learned by word2vec to extract additional syntactic and semantic meanings from variable length text segments. Unfortunately, DMPV and DBOW have been largely evaluated over smaller training tasks that rely only on sentence and paragraph level text segments. For example, DMPV and DBOW have been evaluated for a sentiment analysis task containing an average of 129 words per document, a Question Duplication (Q-Dup) task containing an average of 130 words per document, and a Semantic Textual Similarity (STS) task containing an average of 13 words per document. While results from these studies show a strong performance of doc2vec, the experiments focus on classification tasks with minimally sized documents which do not give a sense of how the models perform using larger text segments.

Other conventional studies performed a preliminary evaluation of DMPV and PDBOW over larger classification tasks and found promising results for evaluating over hand selected tuples from the Wikipedia® database. Further solutions propose skip-thought vectors as a means for learning document embeddings. Skip-thought uses an encoder-decoder neural network architecture to learn sentence vectors. Once the vectors are learned, the decoder makes predictions of proceeding words in the sentence.

Other solutions focus on using a neural network architecture to learn word embeddings from paraphrase-pairs which can be used to learn document embeddings.

Results from both skip-thought and paraphrase-pairs show promise, however doc2vec consistently outperforms skip-thought over multiple experiments. In fact, skip-thought performs poorly even against a simpler method of averaging word2vec vectors. Additionally, paraphrase-pairs performs well over both Q-Dup and STS tasks, while also observing that paraphrase-pairs performs better over shorter documents while DBOW better handles longer documents.

The conventional studies and approaches in NLP demonstrate that an improvement in the quality of document embeddings for larger classification tasks are necessary to advance NLP technologies. In this regard, a new solution is required to utilize syntactic information not previously considered by doc2vec.

### BRIEF SUMMARY OF THE INVENTION

In view of the foregoing, an embodiment herein provides a neural network system comprising one or more computers comprising a memory to store a set of documents comprising textual elements; and a processor to partition the set of documents into sentences and paragraphs; create a segment vector space model representative of the sentences and paragraphs; identify textual classifiers from the segment vector space models; and utilize the textual classifiers for natural language processing of the set of documents. The processor may partition the set of documents into words and sentences. The processor may create the segment vector space model representative of sentences, paragraphs, and words, and documents. The segment vector space model may reduce an amount of processing time used by a computer to perform the natural language processing by using the partitioning of the set of documents into sentences and paragraphs to identify the textual classifiers to create document embeddings without increasing an amount of training data used by the computer to perform text classification of the set of documents. The segment vector space model may reduce an amount of storage space used by the memory to store training data used to perform the natural language processing of the set of documents by using the partitioning of the set of documents into sentences and paragraphs to identify the textual classifiers to create document embeddings without increasing an amount of the training data used by the computer to perform text classification of the set of documents.

Another embodiment provides a machine-readable storage medium comprising computer-executable instructions that when executed cause a processor of a computer to contextually map each document in a set of documents to a unique first vector, wherein the first vector is a graphical vector representation of a document; contextually map each paragraph in the set of documents to a unique second vector, wherein the second vector is a graphical vector representation of a paragraph; contextually map each sentence in the set of documents to a unique third vector, wherein the third vector is a graphical vector representation of a sentence; form a computational matrix that combines the first vector, the second vector, and the third vector; and train a machine learning process with the computational matrix to reduce an amount of computer processing resources used to identify semantic and contextual patterns connecting the set of documents.

In the machine-readable storage medium, wherein the instructions, when executed, may further cause the processor to contextually map each document in the set of documents as a column in the computational matrix. In the machine-readable storage medium, wherein the instructions, when executed, may further cause the processor to contextually map each paragraph in the set of documents as a column in the computational matrix. In the machine-readable storage medium, wherein the instructions, when executed, may further cause the processor to contextually map each sentence in the set of documents as a column in the computational matrix. In the machine-readable storage medium, wherein the instructions, when executed, may further cause the processor to contextually map each word in the set of documents to a unique fourth vector, wherein the fourth vector is a graphical vector representation of a word.

In the machine-readable storage medium, wherein the instructions, when executed, may further cause the processor to contextually map each word in the set of documents as a column in the computational matrix. In the machine-readable storage medium, wherein the instructions, when executed, may further cause the processor to combine the first vector, the second vector, the third vector, and the fourth vector into the computational matrix. In the machine-readable storage medium, wherein the instructions, when executed, may further cause the processor to calculate an average of the first vector, the second vector, and the third vector to represent a document embedding of the set of documents to train the machine learning process. In the machine-readable storage medium, wherein the instructions, when executed, may further cause the processor to calculate an average of the first vector, the second vector, the third vector, and the fourth vector to represent a document embedding of the set of documents to train the machine learning process.

Another embodiment provides a method of training a neural network, the method comprising constructing a pre-training sequence of the neural network by providing a set of documents comprising textual elements; defining in-document syntactical elements to partition the set of documents into sentence, paragraph, and document-level segment vector space models; and merging the sentence, paragraph, and document-level segment vector space models into a single vector space model. The method further comprises inputting the pre-training sequence into a natural language processing training process for training the neural network to identify related text in the set of documents.

The neural network may comprise a machine learning system comprising any of logic regression, support vector machines, and K-means processing. The method may further comprise defining in-document syntactical elements to partition the set of documents into word-level segment vector space models. The method may further comprise merging the word-level segment vector space models with the sentence, paragraph, and document-level segment vector space models into the single vector space model. Inputting the pre-training sequence into the natural language processing training process may reduce an amount of computational processing resources used by a computer to define the syntactical elements in the set of documents. The natural language processing training process may comprise text classification and sentiment analysis of the set of documents.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic block diagram illustrating a neural network system to conduct natural language processing of a set of documents, according to an embodiment herein;

FIG. 2 is a schematic block diagram illustrating the partitioning of the set of documents by the processor in the neural network system of FIG. 1, according to an embodiment herein;

FIG. 3 is a schematic block diagram illustrating creating the segment vector space model by the processor in the neural network system of FIG. 1, according to an embodiment herein;

FIG. 4 is a schematic block diagram illustrating using the segment space model of the neural network system of FIG. 1 to reduce computer processing time, according to an embodiment herein;

FIG. 5 is a schematic block diagram illustrating using the segment space model of the neural network system of FIG. 1 to reduce memory storage space requirements, according to an embodiment herein;

FIG. 6A is schematic diagram illustrating the vectors and their representations of the segment vector space model of the neural network system of FIG. 1, according to an embodiment herein;

FIG. 6B is a schematic diagram illustrating formation of a first computational matrix based on the vectors of the segment vector space model of FIG. 6A, according to an embodiment herein;

FIG. 6C is a schematic diagram illustrating formation of a second computational matrix based on the vectors of the segment vector space model of FIG. 6A, according to an embodiment herein;

FIG. 6D is a schematic diagram illustrating a distributed memory version of a segment vector space model, according to an embodiment herein;

FIG. 6E is a schematic diagram illustrating a distributed bag of words approach in a segment vector space model, according to an embodiment herein;

FIG. 7A is a block diagram illustrating a system to train a machine learning process in a computer, according to an embodiment herein;

FIG. 7B is a block diagram illustrating a system for mapping documents, paragraphs, sentences, and words in a computational matrix, according to an embodiment herein;

FIG. 7C is a block diagram illustrating a system for using vectors for training a machine learning process, according to an embodiment herein;

FIG. 8A is a flow diagram illustrating a method of training a neural network according to an embodiment herein;

FIG. 8B is a flow diagram illustrating a method of forming a single vector space model, according to an embodiment herein; and

FIG. 9 is a graphical representation illustrating experimental results of classifier accuracy as the size of the training set increases, according to an embodiment herein.

### DETAILED DESCRIPTION OF THE INVENTION

Embodiments of the disclosed invention, its various features and the advantageous details thereof, are explained more fully with reference to the non-limiting embodiments that are illustrated in the accompanying drawings and detailed in the following description. Descriptions of well-known components and processing techniques are omitted to not unnecessarily obscure what is being disclosed. Examples may be provided and when so provided are intended merely to facilitate an understanding of the ways in which the invention may be practiced and to further enable those of skill in the art to practice its various embodiments. Accordingly, examples should not be construed as limiting the scope of what is disclosed and otherwise claimed.

The embodiments herein provide a processing technique for training a neural network. The technique comprises constructing a pre-training sequence of the neural network by providing a set of documents comprising textual elements; defining in-document syntactical elements to partition the set of documents into sentence, paragraph, and document-level segment vector space models; and merging the sentence, paragraph, and document-level segment vector space models into a single vector space model. Thereafter, the pre-training sequence is input into a natural language processing training process for training the neural network to identify related text in the set of documents.

The embodiments herein further provide a pre-training processing technique to generate document-level neural embeddings, noted as segment vectors, which can be leveraged by doc2vec. This is demonstrated as syntactical in-document information, which is otherwise ignored during conventional neural network training techniques, and which can improve doc2vec's performance on larger classification tasks.

More specifically, the embodiments herein provide a pre-processing technique to partition data into paragraph and sentence segments to improve the quality of a vector space model generation process. Furthermore, doc2vec specifically focuses on learning document embeddings which are treated only as a unique word within the embedding space during training. The approach provided by the embodiments herein appends a new word for each document within the training corpus to the token list. The segment vector approach builds on this architecture by creating sentence and paragraph level unique tokens which are appended to the token list. By learning the sentence and paragraphs vectors in addition to the document vectors, the technique provided by the embodiments herein creates a more powerful and informative embedding space. During training, doc2vec uses the tokens within a document to learn the embedding of the unique document vector. The more iterations or steps the process runs, the more the embedding is modified to best represent where the document lies within the vector space model. In the segment vector approach, the embodiments herein model all documents, paragraphs, and sentences as separate entities vs. only the document as provided by conventional techniques. Accordingly, when the process is trained over large documents, the learned embedding is not useful. Conversely, by using sentences and paragraphs, the technique provided by the embodiments herein generate embeddings that are stronger (i.e., more informative and useful). Once the embeddings are learned, the technique provided by the embodiments herein evaluates them by taking the component-wise mean for all sentence and paragraph vectors with a single document vector. This new vector is used to train a logistic regression text classifier to label new incoming documents.

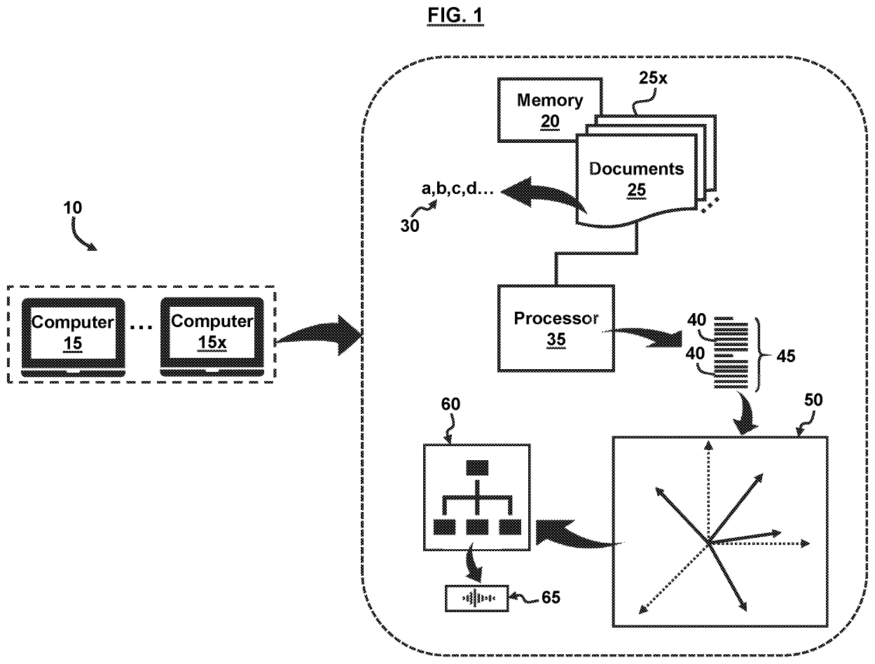

Referring now to the drawings, and more particularly to FIGS. 1 through 9, where similar reference characters denote corresponding features consistently throughout, there are shown exemplary embodiments. In the drawings, the size and relative sizes of components, layers, and regions may be exaggerated for clarity.

In some examples, the various devices and processors described herein and/or illustrated in the figures may be embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing digital and/or analog signals for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be configured as physical locations in computer memory and can be a variable, a data structure, or a function. In the embodiments configured as relational databases (e.g., such Oracle® relational databases), the data objects can be configured as a table or column. Other configurations include specialized objects, distributed objects, object-oriented programming objects, and semantic web objects, for example. The data object models can be configured as an application programming interface for creating HyperText Markup Language (HTML) and Extensible Markup Language (XML) electronic documents. The models can be further configured as any of a tree, graph, container, list, map, queue, set, stack, and variations thereof. The data object files are created by compilers and assemblers and contain generated binary code and data for a source file. The database components can include any of tables, indexes, views, stored procedures, and triggers.

FIG. 1 illustrates a neural network system 10 comprising one or more computers 15 . . . 15x. In some examples, the one or more computers 15 . . . 15x may comprise desktop computers, laptop computers, tablet or other handheld computers, servers, or any other type of computing device. The one or more computers 15 . . . 15x may be communicatively linked through a network (not shown). The one or more computers 15 . . . 15x may comprise a memory 20 to store a set of documents 25 . . . 25x comprising textual elements 30. In some examples, the memory 20 may be Random Access Memory, Read-Only Memory, a cache memory, hard drive storage, flash memory, or other type of storage mechanism, according to an example. The set of documents 25 . . . 25x may comprise electronic documents containing any of text, words, audio, video, and any other electronically-configured data object. The textual elements 30 may comprise any of alphanumeric characters, symbols, mathematical operands, and graphics, and may be arranged in an ordered or arbitrary sequence.

The one or more computers 15 . . . 15x may also comprise a processor 35. In some examples, the processor 35 may comprise a central processing unit (CPU) of the one or more computers 15 . . . 15x. In other examples the processor 35 may be a discrete component independent of other processing components in the one or more computers 15 . . . 15x. In other examples, the processor 35 may be a microprocessor, microcontroller, hardware engine, hardware pipeline, and/or other hardware-enabled device suitable for receiving, processing, operating, and performing various functions required by the one or more computers 15 . . . 15x. The processor 35 is configured to partition the set of documents 25 . . . 25x into sentences 40 and paragraphs 45. In this regard, according to an example, the set of documents 25 . . . 25x may be partitioned into sentences 40 and paragraphs 45 by utilizing a search algorithm to identify instances of sentences 40 and paragraphs 45 contained in the set of documents 25 . . . 25x such that the memory 20 may store the sentences 40 and paragraphs 45 as identified components of the set of documents 25 . . . 25x; e.g., assigned an identifier that indicates the partitioned components of the set of documents 25 . . . 25x as sentences 40 and paragraphs 45. In another example, the sentences 40 and paragraphs 45 may be stored in the memory 20 as separate or discrete elements apart from the set of documents 25 . . . 25x. According to some examples, the sentences 40 and paragraphs 45 are not restricted by any particular length.

The processor 35 is configured to create a segment vector space model 50 representative of the sentences 40 and paragraphs 45. The segment vector space model 50 may be configured as an electronic algebraic model for representing the set of documents 25 . . . 25x documents as dimensional vectors of identifiers, such as, for example, indexed terms associated with the sentences 40 and paragraphs 45. According to an example, the segment vector space model 50 may be configured as a three-dimensional model capable of being electronically stored in the memory 20.

The processor 35 is configured to identify textual classifiers 60 from the segment vector space model 50. In an example, the textual classifiers 60 may be a computer-programmable set of rules or instructions for the processor 35 to follow. Moreover, the textual classifiers 60 may be linear or nonlinear classifiers. The processor 35 is configured to utilize the textual classifiers 60 for natural language processing 65 of the set of documents 25 . . . 25x.

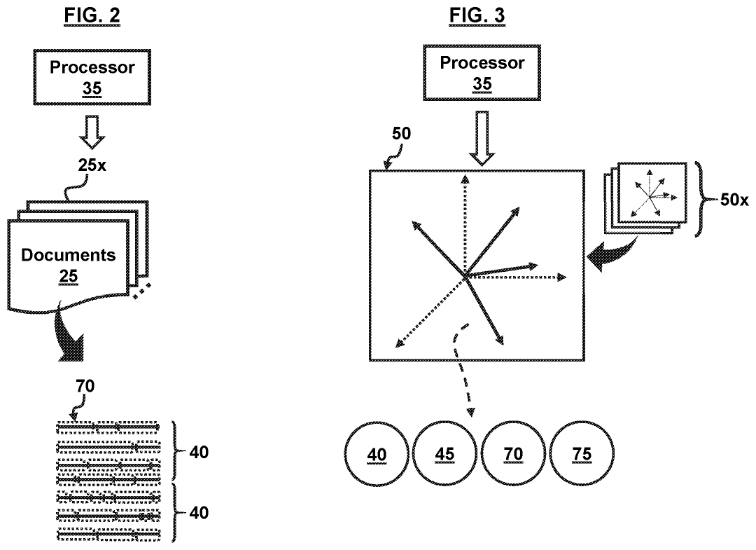

FIG. 2, with reference to FIG. 1, illustrates that the processor 35 is to partition the set of documents 25 . . . 25x into words 70 and sentences 40. The words 70 and sentences 40 may contain text, images, symbols, or any other type of characters, and may be of any length. The partitioning process may occur using any suitable parsing technique that can be programmed for execution by the processor 35. In an example, the partitioning process may occur dynamically as the set of documents 25 . . . 25x change due to real-time updates to the set of documents 25 . . . 25x.

FIG. 3, with reference to FIGS. 1 and 2, illustrates that the processor 35 is to create the segment vector space model 50 representative of the sentences 40, paragraphs 45, words 70, and documents 75. According to an example, each vector of the segment vector space model 50 may be representative of the sentences 40, paragraphs 45, words 70, and documents 75. Moreover, the sentences 40, paragraphs 45, words 70, and documents 75 may be overlapping or discrete from one another according to various examples. The documents 75 may be one or more documents from the overall set of documents 25 . . . 25x. In accordance with other examples, multiple segment vector space models 50x may be combined to form a single segment vector space model 50.

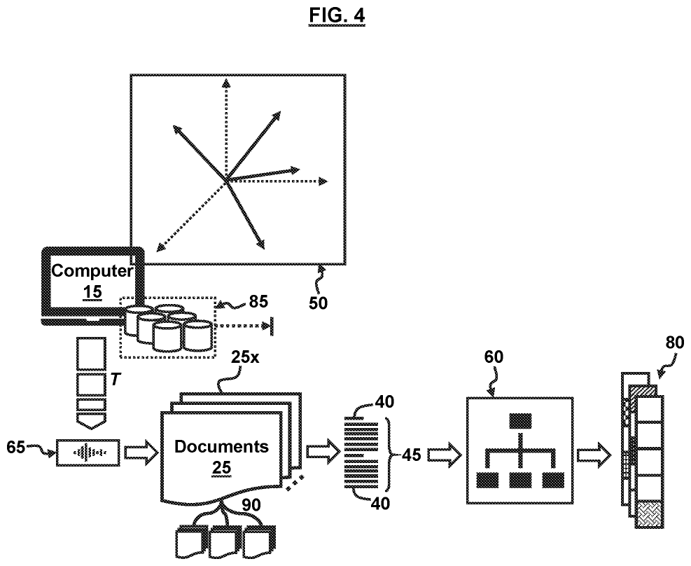

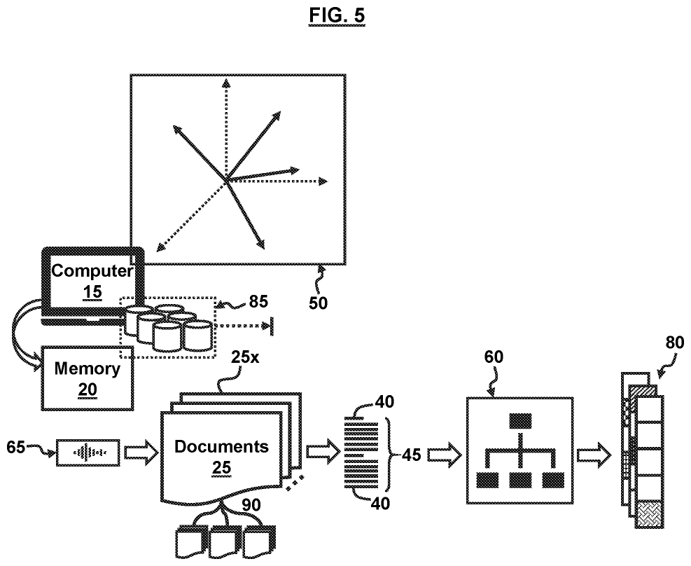

FIG. 4, with reference to FIGS. 1 through 3, illustrates that the segment vector space model 50 is to reduce an amount of processing time Tused by a computer (e.g., computer 15 of the one or more computers 15 . . . 15x) to perform the natural language processing 65 by using the partitioning of the set of documents 25 . . . 25x into sentences 40 and paragraphs 45 to identify the textual classifiers 60 to create document embeddings 80 without increasing an amount of training data 85 used by the computer (e.g., computer 15 of the one or more computers 15 . . . 15x) to perform text classification 90 of the set of documents 25 . . . 25x. Additionally, as indicated in FIG. 5, with reference to FIGS. 1 through 4, the segment vector space model 50 is to reduce an amount of storage space used by the memory 20 to store training data 85 used to perform the natural language processing 65 of the set of documents 25 . . . 25x by using the partitioning of the set of documents 25 . . . 25x into sentences 40 and paragraphs 45 to identify the textual classifiers 60 to create document embeddings 80 without increasing the amount of training data 85 used by the computer (e.g., computer 15 of the one or more computers 15 . . . 15x) to perform text classification 90 of the set of documents 25 . . . 25x.

The reduction in processing time T used by the computer (e.g., computer 15 of the one or more computers 15 . . . 15x) to perform the natural language processing 65 and the reduction in the amount of storage space used by the memory 20 to store training data 85 used to perform the natural language processing 65 may occur based on the lack of redundancy in analyzing the set of documents 25 . . . 25x. In an example, the storage space may be configured as a cache memory 20, which only utilizes limited storage of the training data 85 instead of permanent storage. In this regard, the memory 20 may not permanently store the set of documents 25 . . . 25x, and as such the processor 35 may analyze the set of documents 25 . . . 25x from their remotely-hosted locations in a network.

The segment vector space model 50 generates document embeddings 80 which utilize syntactic elements ignored by doc2vec during training. While doc2vec only utilizes documents and word-level vectors, the segment vector space model 50 jointly learns document-level document embeddings 80 over words 70, sentences 40, paragraphs 45, and a document 75. Stronger document embeddings 80 are created by averaging the learned sentences 40, paragraphs 45, words 70, and documents 75 and document embeddings 80 together.

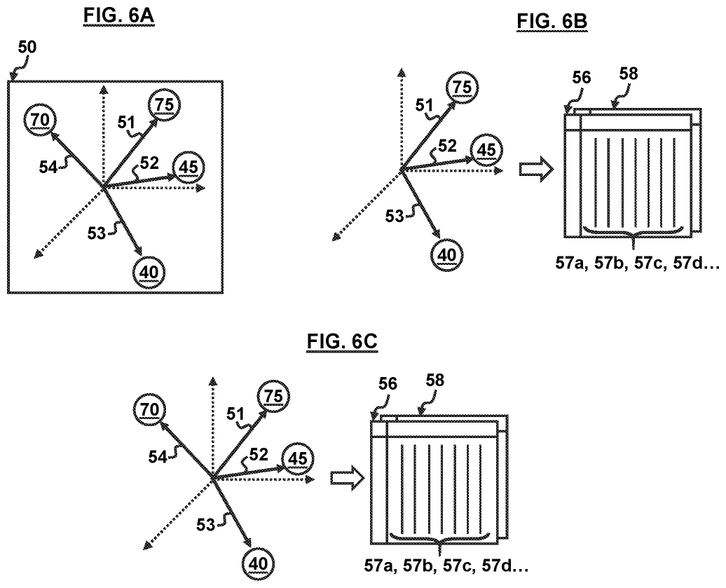

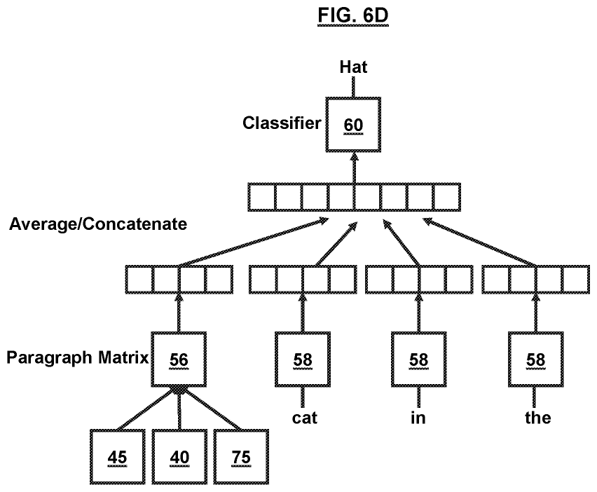

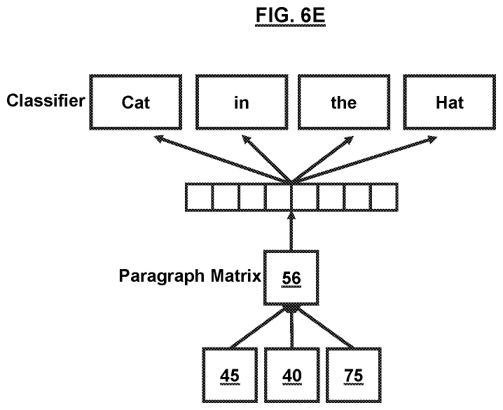

In an example shown in FIG. 6A, with reference to FIGS. 1 through 5, the segment vector space model 50 may comprise a first vector 51, a second vector 52, a third vector 53, and a fourth vector 54. The first vector 51 is a graphical vector representation of a document 75. The second vector 52 is a graphical vector representation of a paragraph 45. The third vector 53 is a graphical vector representation of a sentence 40. The fourth vector 54 is a graphical vector representation of a word 70. According to FIG. 6B, with reference to FIGS. 1 through 6A, a computational matrix 56 may combine the first vector 51, the second vector 52, and the third vector 53 in one example. In another example shown in FIG. 6C, with reference to FIGS. 1 through 6B, the computational matrix 56 may combine the first vector 51, the second vector 52, the third vector 53, and the fourth vector 54. The computational matrix 56 may comprise a set of columns 57a, 57b, 57c, 57d. . . .

In DMPV, each document 75 of a training corpus (e.g., a set of documents 25 . . . 25x) is assigned a special token and is mapped to a unique vector (e.g., first vector 51, second vector 52, third vector 53, and fourth vector 54) as a column in the computational matrix 56. Each word 70 within each document 75 in the set of documents 25 . . . 25x is also assigned a special token and mapped to a unique vector (e.g., first vector 51, second vector 52, third vector 53, and fourth vector 54) represented by a column in a second computational matrix 58. Once vectors (e.g., first vector 51, second vector 52, third vector 53, and fourth vector 54) are formed, training is performed by concatenating document and word tokens within a given window to predict the next word in a sequence.

In the Distributed Memory with Segment Vector (DMSV) model (e.g., segment vector space model 50), the same training regimen is followed as DMPV, but the computational matrix 56 is enhanced to include additional columns 57a, 57b, 57c, 57d. . . . that represent tokens associated with every paragraph 45 and every sentence 40 within the document 75 of the set of documents 25 . . . 25x. FIG. 6D, with reference to FIGS. 1 through 6C, illustrates a schematic diagram of the segment vector space model 50 in accordance with an example herein utilizing words “cat”, “in”, and “the” to generate a textual classifier 60 “Hat”.

More formally, the DMSV approach involves the following example process: Each document 75 of the set of documents 25 . . . 25x is mapped to a unique vector dᵢ (e.g., first vector 51) as a column (e.g., column 57a) in computational matrix 56. Each paragraph 45 is mapped to a unique vector pⱼ (e.g., second vector 52) as a column (e.g., column 57b) in computational matrix 56 where n is the number of paragraphs 45 in dᵢ. Each sentence 40 is mapped to a unique vector sₖ (e.g., third vector 53) as a column (e.g., column 57c) in computational matrix 56 where m is the number of sentences 40 in pⱼ, and each word 70 is mapped to a unique vector (e.g., fourth vector 54) represented by a column (e.g., column 57d) in computational matrix 58. The set of all document, paragraph, and sentence vectors (e.g., first, second, and third vectors 51, 52, 53) are referred to herein as segment vectors.

The segment vector space model 50 also provides a variation of DMSV, which is based on DBOW called Distributed Bag-of-Words with Segment Vectors (DBOW-SV). Similar to DMSV, the DBOW-SV model includes sentences 40, paragraphs 45, and documents 75 in the computational matrix 56. The DBOW-SV model is then trained similarly to DBOW where the prediction task is to use a single segment token to predict a random set of tokens from the vocabulary within a specified context window as shown in FIG. 6E, with reference to FIGS. 1 through 6D.

As in doc2vec, after being trained, the vectors (e.g., first, second, and third vectors 51, 52, 53) found through DMSV or DBOW-SV can be used as features for sentences 40, paragraphs 45, and documents 75 found within the training corpus (e.g., set of documents 25 . . . 25x). These features can be fed directly to downstream machine learning algorithms such as logistic regression, support vector machines, or K-means. As such, the segment vector space model 50 creates a stronger global representation of longer documents containing rich syntactic information, which is ignored when training doc2vec in conventional solutions.

The segment vector space model 50 does not modify the doc2vec prediction task in DMSV or DBOW-SV. Rather, the segment vector space model 50 only modifies the computational matrix 56 to create a larger set of paragraph vectors (e.g., second vector 52). Each document, paragraph, and sentence vector (e.g., first, second, and third vectors 51, 52, 53) within the computational matrix 56 is used in its own prediction task. As further described below in the example experiment, the learned segment vectors can be averaged together to represent a document embedding 80 and enable a variety of downstream classification tasks.

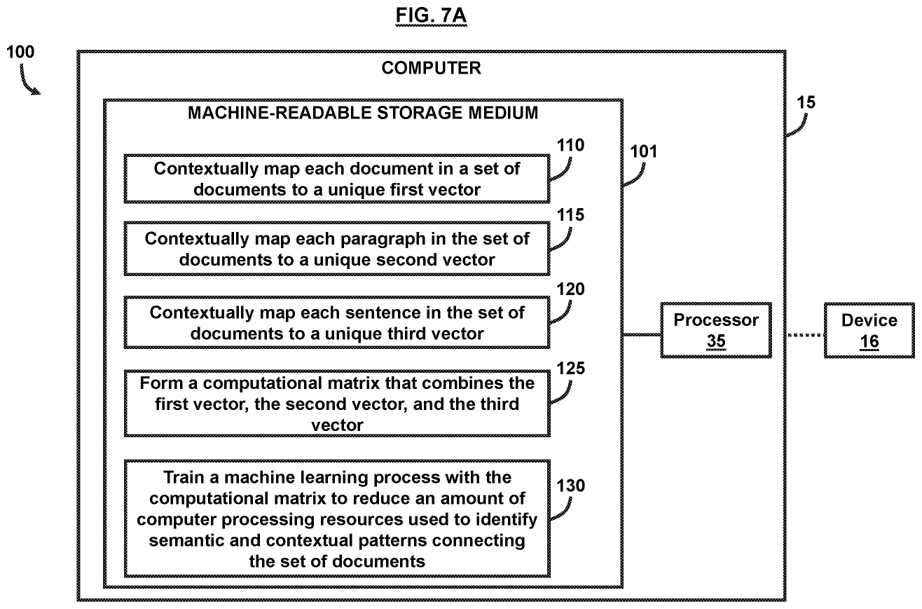

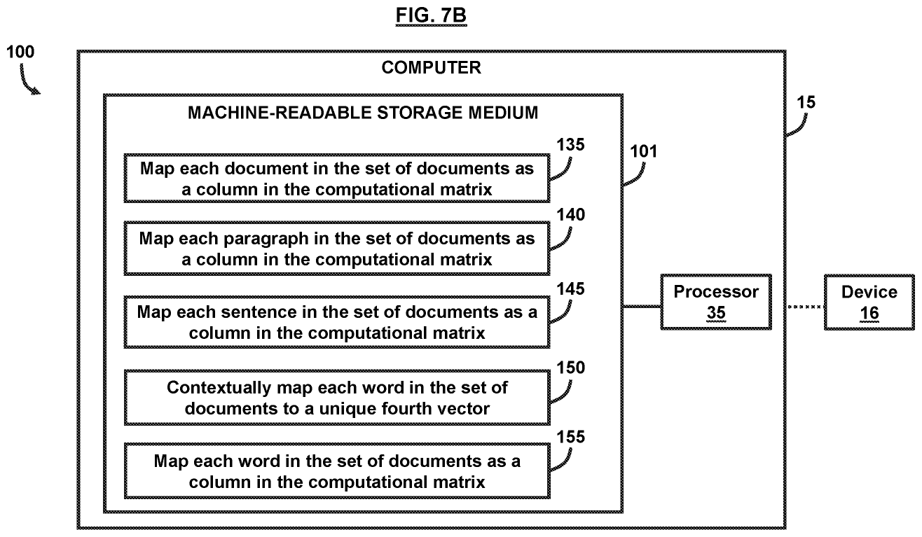

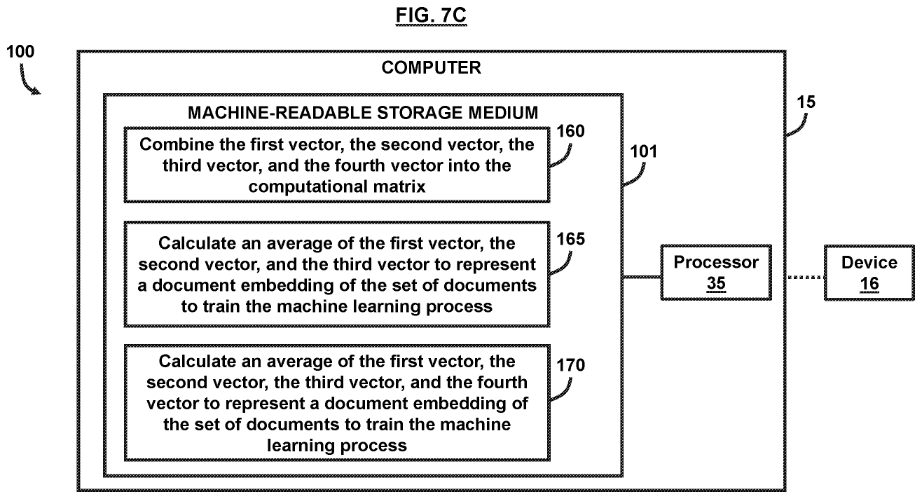

FIGS. 7A through 7C, with reference to FIGS. 1 through 6C, illustrates an example system 100 to train a machine learning process in a computer (e.g., computer 15 of the one or more computers 15 . . . 15x). In the examples of FIGS. 7A through 7C, the computer (e.g., computer 15 of the one or more computers 15 . . . 15x) includes the processor 35 and a machine-readable storage medium 101.

Processor 35 may include a central processing unit, microprocessors, microcontroller, hardware engines, and/or other hardware devices suitable for retrieval and execution of computer-executable instructions 105 stored in a machine-readable storage medium 101. Processor 35 may fetch, decode, and execute computer-executable instructions 110, 115, 120, 125, 130, 135, 140, 145, 150, 155, 160, 165, and 170 to enable execution of locally-hosted or remotely-hosted applications for controlling action of the computer (e.g., computer 15 of the one or more computers 15 . . . 15x). The remotely-hosted applications may be accessible on one or more remotely-located devices; for example, communication device 16. For example, the communication device 16 may be a computer, tablet device, smartphone, or remote server. As an alternative or in addition to retrieving and executing instructions, processor 35 may include one or more electronic circuits including a number of electronic components for performing the functionality of one or more of the instructions 110, 115, 120, 125, 130, 135, 140, 145, 150, 155, 160, 165, and 170.

The machine-readable storage medium 101 may be any electronic, magnetic, optical, or other physical storage device that stores computer-executable instructions 105. Thus, the machine-readable storage medium 101 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the machine-readable storage medium 101 may include a non-transitory computer-readable storage medium. The machine-readable storage medium 101 may be encoded with executable instructions for enabling execution of remotely-hosted applications accessed on the one or more remotely-located devices 16.

In an example, the processor 35 of the computer (e.g., computer 15 of the one or more computers 15 . . . 15x) executes the computer-executable instructions 110, 115, 120, 125, 130, 135, 140, 145, 150, 155, 160, 165, and 170. For example, mapping instructions 110 may contextually map each document 75 in a set of documents 25 . . . 25x to a unique first vector 51, wherein the first vector 51 is a graphical vector representation of a document 75. Mapping instructions 115 may contextually map each paragraph 45 in the set of documents 25 . . . 25x to a unique second vector 52, wherein the second vector 52 is a graphical vector representation of a paragraph 45. Mapping instructions 120 may contextually map each sentence 40 in the set of documents 25 . . . 25x to a unique third vector 53, wherein the third vector 53 is a graphical vector representation of a sentence 40. Forming instructions 125 may form a computational matrix 56 that combines the first vector 51, the second vector 52, and the third vector 53. Training instructions 130 may train a machine learning process with the computational matrix 56 to reduce an amount of computer processing resources used to identify semantic and contextual patterns connecting the set of documents 25 . . . 25x. Mapping instructions 135 may map each document 75 in the set of documents 25 . . . 25x as a column 57a in the computational matrix 56.

Mapping instructions 140 may map each paragraph 45 in the set of documents 25 . . . 25x as a column 57b in the computational matrix 56. Mapping instructions 145 may contextually map each sentence 40 in the set of documents 25 . . . 25x as a column 57c in the computational matrix 56. Mapping instructions 150 may contextually map (150) each word 70 in the set of documents 25 . . . 25x to a unique fourth vector 54, wherein the fourth vector 54 is a graphical vector representation of a word 70. Mapping instructions 155 may contextually map each word 70 in the set of documents 25 . . . 25x as a column 57d in the computational matrix 56. Combining instructions 160 may combine the first vector 51, the second vector 52, the third vector 53, and the fourth vector 54 into the computational matrix 56. Calculating instructions 165 may calculate an average of the first vector 51, the second vector 52, and the third vector 53 to represent a document embedding 80 of the set of documents 25 . . . 25x to train the machine learning process. Calculating instructions 170 may calculate an average of the first vector 51, the second vector 52, the third vector 53, and the fourth vector 54 to represent a document embedding 80 of the set of documents 25 . . . 25x to train the machine learning process.

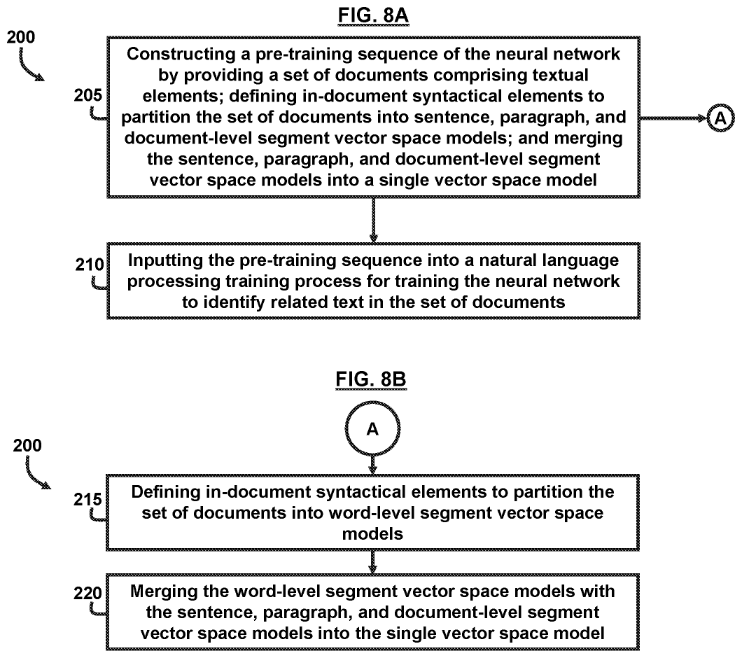

FIGS. 8A through 8B, with reference to FIGS. 1 through 7C, are flow diagrams illustrating a method 200 of training a neural network (e.g., neural network system 10), the method 200 comprises (as shown in FIG. 8A) constructing (205) a pre-training sequence of the neural network (e.g., neural network system 10). The pre-training sequence may be constructed (205) by providing a set of documents 25 . . . 25x comprising textual elements 30; defining in-document syntactical elements to partition the set of documents 25 . . . 25x into sentence, paragraph, and document-level segment vector space models 50x; and merging the sentence, paragraph, and document-level segment vector space models 50x into a single vector space model 50. The method 200 further comprises inputting (210) the pre-training sequence into a natural language processing training process (i.e., natural language processing 65) for training the neural network to identify related text in the set of documents 25 . . . 25x. Inputting (210) the pre-training sequence into the natural language processing training process (i.e., natural language processing 65) may reduce an amount of computational processing resources used by a computer (e.g., computer 15 of the one or more computers 15 . . . 15x) to define the syntactical elements in the set of documents 25 . . . 25x. For example, the amount of processing time T and the amount of required storage space used by the memory 20 may be reduced.

The neural network (e.g., neural network system 10) may comprise a machine learning system comprising any of logic regression, support vector machines, and K-means processing. As shown in FIG. 8B, the method 200 may further comprise defining (215) in-document syntactical elements to partition the set of documents 25 . . . 25x into word-level segment vector space models 55x. The method 200 may further comprise merging (220) the word-level segment vector space models 55x with the sentence, paragraph, and document-level segment vector space models 50x into the single vector space model 50. The natural language processing training process (i.e., natural language processing 65) may comprise text classification and sentiment analysis of the set of documents 25 . . . 25x, as further described below with respect to the experiments.

Experiments

To better understand how the segment vector space model 50 compares to DMPV and DBOW, a set of four experiments were conducted over two primary evaluation tasks: sentiment analysis and text classification. To stay consistent with previous evaluations, pre-defined test sets are used when available. However, tenfold cross-validation is used to evaluate tasks when no community agreed upon test split has been defined for a given dataset. In each experiment doc2vec is trained with the optimal hyper-parameters shown in Table 1. Additionally, vector representations are learned using all available data, including test data.

TABLE 1
Hyper-parameter selection

| Parameter | Value | Definition |
|---|---|---|
| Dimension | 300 | Dimensionality of feature vectors |
| Window Size | 15 | Maximum window size |
| Sub-Sampling | 10⁻⁵ | Threshold of downsampled |
| | | high-frequency words |
| Negative Sample | 5 | Number of noise-words used |
| Min Count | 1 | Minimum word frequency |
| Epochs | 100 | Training iterations |

Experimentally, the method 200 partitions the set of documents 25 . . . 25x into sentences 40 and paragraphs 45 before training. Therefore, after training, the component-wise mean of all vectors pertaining to a given document 75 are generated to generate a new document embedding 80 for downstream evaluation tasks. This is shown in Equation (2), where dᵢ_{ₒ} is the document vector originally learned from the experimental training procedure.

$${d}_{i} = \frac{1}{1 + n + m} ( {d}_{{i}_{0}} + {\sum }_{j = 1}^{n} {p}_{j} + {\sum }_{k = 1}^{m} {s}_{k} ) \qquad ( 2 )$$

Example: Sentiment Analysis with Movie Reviews

The segment vector space model 50 is compared to doc2vec by evaluating over two sentiment analysis tasks using movie reviews from the Rotten Tomatoes dataset and the IMIDB® dataset. The amount of syntactic information in each dataset (paragraphs 45 and sentences 40) is minimal. Additionally, it provides an opportunity to investigate the impact of segment vectors on text classification tasks with low syntactic information. In the experiments, the segment vectors and doc2vec are evaluated against fine-grain sentiment analysis tasks (e.g., Very Negative, Negative, Neutral, Positive, Very Positive).

The Rotten Tomatoes® dataset is composed of post-processed sub-phrases from experiments with sentiment analysis techniques. Each sub-phrase is treated as a paragraph vector during training rather than only using the complete sentences. The samples are pre-pad containing fewer than 10 tokens with NULL symbols. Additionally, during training DMSV and DBOW-SV, samples containing only one sentence are copied into three segments representing sentence, paragraph, and document-level segments.

Once the embeddings are learned by each model, they are fed to a logistic regression classifier for evaluation. Each stand-alone algorithm (DBOW, DMPV, DMSV, and DBOW-SV) produces learned embeddings for their individual classification tasks. For DMSV and DBOW-SV, individual document embeddings are found by calculating the component-wise mean of all vectors pertaining to any given document as shown in Equation (2).

Table 2 shows that the experiments were able to reproduce findings for the fine-grain classification task, confirming that for these datasets, DMPV slightly outperforms DBOW. Additionally, DMSV and DBOW-SV provide moderate improvements, showing that segment vectors may provide additional useful information for classification. The improvements may be moderate because the data samples do not contain a large amount of syntactic information which can be leveraged.

TABLE 2
Results from experiments using movie reviews

| Domain | DMPV | DMSV | DBOW | DBOW-SV |
|---|---|---|---|---|
| Rotten Tomatoes ® dataset | 49.69 | 49.77 | 49.54 | 49.52 |
| (Fine-Grain) | | | | |
| IMDB ® dataset | 86.81 | 87.11 | 88.70 | 88.84 |

Example: Text Classification with News Reports

The four models are also experimentally evaluated over two classification tasks that contain a larger number of sentences and paragraphs per sample: Newsgroup20 and Reuters-21578 datasets. Newsgroup20 contains 20K documents binned in a total of 20 different news topic groups. The classification task is to predict the topic area of each document. Reuters-21578 contains over 22K documents mapping to a total of 22 unique categories, and has a similar classification task. Both datasets contain more syntactic information than the movie dataset experiment, which allows the segment vectors to demonstrate improved results.

As indicated above, after embeddings are learned by each model they are fed to a logistic regression classifier for evaluation. Each stand-alone algorithm (DBOW, DMPV, DMSV, and DBOW-SV) is tied to an individual classification task. Results are shown in Table 3.

TABLE 3
Text classification over news dataset

| Domain | DMPV | DMSV | DBOW | DBOW-SV |
|---|---|---|---|---|
| Newsgroup20 dataset | 30.80 | 70.69 | 75.63 | 74.94 |
| Reuters-21578 dataset | 44.20 | 75.45 | 77.18 | 58.91 |

The results show that DBOW outperforms DMPV when used for the larger classification tasks. This is contrary to the previous experiment for smaller classification tasks where DBOW and DMPV performed similarly. Although DBOW obtains the best accuracy for these datasets, when comparing DMPV to DMSV, the results demonstrate an approximately 40 percentage point increase for Newsgroup20 and a 31 percentage point increase for Reuters-21578. It seems that segment vectors allow DMPV to take advantage of the additional syntactic information provided within these larger documents.

The segment vectors with DBOW show a decrease in accuracy. In the case of Reuters-21578 the decrease is 18 percentage points. However, for Newsgroup20 the drop is less than 1 percentage point. It is possible that segment vectors lead to overfitting in this regime, or that the bag of words concept does not benefit from the additional syntactic information.

Creating segment vectors for a given corpus increases the number of prediction tasks each document contributes to the training of the document embeddings. For example, a document made of three sentences will have three additional columns in the computational matrix 56, leading to additional training opportunities. As such, training with segment vectors may allow smaller text corpora to lead to helpful document embeddings.

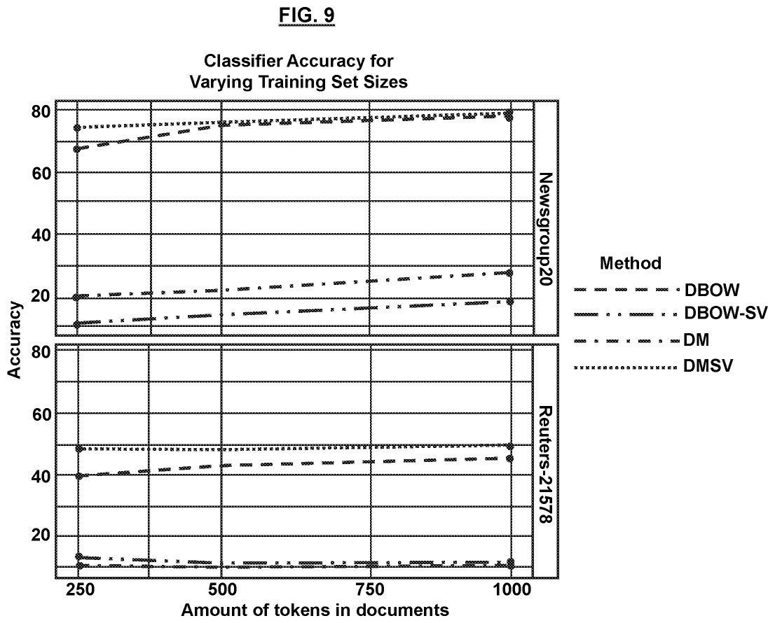

In this experiment, the size of the training set is altered. Specifically, the training data is restricted to contain only samples that have at least 250 words. Then, either 250, 500, or 1000 documents are randomly selected to learn embeddings and evaluate using a logistic regression classifier. Again, results are calculated using 10-fold cross-validation. Results are shown in FIG. 9. The findings show that DMSV outperforms all other methods for tasks using smaller corpora.

The results show an increase in accuracy for the Distributed Memory (DM) approach to learning the embeddings. The vectors produced by DM improve the accuracy of the classifier by almost two times. By partitioning the data into sentences and paragraphs, the process may take longer to train. This is due to an increase of information being provided to the prediction task within the process itself. The more document, paragraph, or sentence examples, the more time doc2vec will take to train.

The embodiments herein provide a pre-processing technique; i.e., segment vectors, for document embedding generation. Segment vectors are generated by leveraging additional in-document syntactic information that is included within the doc2vec training regimen, relating to documents, paragraphs and sentences. By leveraging additional in-document syntactic information, the embodiments herein provide improvements over doc2vec across multiple evaluation tasks. The experimental results show DMSV can significantly increase the quality of the document embedding space by an average of 38% over the two larger text classification tasks. This may be a direct result from appending additional sentence and paragraph level tokens to a training set of documents 25 . . . 25x prior to training.

Additionally, when limiting the corpus size, DMSV produces a stronger model over all other conventional approaches. When using 250-500 samples, it is seen that DMSV outperforms all other models. Additional syntactical information can strongly benefit DMPV and increase accuracy over large classification tasks by a substantial margin which could highly benefit downstream general-purpose applications.

There are several applications for the segment vector space model 50 including, for example, actuarial services, medical and scientific research, legal discovery, business document templates, economic and market data analysis, human resource data analysis, social media trend analysis, knowledge management, military/law enforcement, and computer security and malware detection.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Those skilled in the art will recognize that the embodiments herein can be practiced with modification within the spirit and scope of the appended claims.

What is claimed is:

1. A neural network system comprising one or more computers comprising:
a memory to store a set of documents comprising textual elements; and
a processor to:
partition the set of documents into sentences and paragraphs;
create a segment vector space model representative of the sentences and paragraphs;
identify textual classifiers from the segment vector space model; and
utilize the textual classifiers for natural language processing of the set of documents.

2. The neural network system of claim 1, wherein the processor is to partition the set of documents into words and sentences.

3. The neural network system of claim 1, wherein the processor is to create the segment vector space model representative of sentences, paragraphs, and words.

4. The neural network system of claim 1, wherein the segment vector space model is to reduce an amount of processing time used by a computer to perform the natural language processing by using the partitioning of the set of documents into sentences and paragraphs to identify the textual classifiers to create document embeddings without increasing an amount of training data used by the computer to perform text classification of the set of documents.

5. The neural network system of claim 1, wherein the segment vector space model is to reduce an amount of storage space used by the memory to store training data used to perform the natural language processing of the set of documents by using the partitioning of the set of documents into sentences and paragraphs to identify the textual classifiers to create document embeddings without increasing an amount of the training data used by the computer to perform text classification of the set of documents.

6. A machine-readable storage medium comprising computer-executable instructions that when executed cause a processor of a computer to:
contextually map each document in a set of documents to a unique first vector, wherein the first vector is a graphical vector representation of a document;
contextually map each paragraph in the set of documents to a unique second vector, wherein the second vector is a graphical vector representation of a paragraph;
contextually map each sentence in the set of documents to a unique third vector, wherein the third vector is a graphical vector representation of a sentence;
form a computational matrix that combines the first vector, the second vector, and the third vector; and
train a machine learning process with the computational matrix to reduce an amount of computer processing resources used to identify semantic and contextual patterns connecting the set of documents.

7. The machine-readable storage medium of claim 6, wherein the instructions, when executed, further cause the processor to contextually map each document in the set of documents as a column in the computational matrix.

8. The machine-readable storage medium of claim 6, wherein the instructions, when executed, further cause the processor to contextually map each paragraph in the set of documents as a column in the computational matrix.

9. The machine-readable storage medium of claim 6, wherein the instructions, when executed, further cause the processor to contextually map each sentence in the set of documents as a column in the computational matrix.

10. The machine-readable storage medium of claim 6, wherein the instructions, when executed, further cause the processor to contextually map each word in the set of documents to a unique fourth vector, wherein the fourth vector is a graphical vector representation of a word.

11. The machine-readable storage medium of claim 10, wherein the instructions, when executed, further cause the processor to contextually map each word in the set of documents as a column in the computational matrix.

12. The machine-readable storage medium of claim 10, wherein the instructions, when executed, further cause the processor to combine the first vector, the second vector, the third vector, and the fourth vector into the computational matrix.

13. The machine-readable storage medium of claim 6, wherein the instructions, when executed, further cause the processor to calculate an average of the first vector, the second vector, and the third vector to represent a document embedding of the set of documents to train the machine learning process.

14. The machine-readable storage medium of claim 10, wherein the instructions, when executed, further cause the processor to calculate an average of the first vector, the second vector, the third vector, and the fourth vector to represent a document embedding of the set of documents to train the machine learning process.

15. A method of training a neural network, the method comprising:
constructing a pre-training sequence of the neural network by:
providing a set of documents comprising textual elements;
defining in-document syntactical elements to partition the set of documents into sentence, paragraph, and document-level segment vector space models; and
merging the sentence, paragraph, and document-level segment vector space models into a single vector space model;
inputting the pre-training sequence into a natural language processing training process for training the neural network to identify related text in the set of documents.

16. The method of claim 15, wherein the neural network comprises a machine learning system comprising any of logic regression, support vector machines, and K-means processing.

17. The method of claim 15, further comprising defining in-document syntactical elements to partition the set of documents into word-level segment vector space models.

18. The method of claim 17, further comprising merging the word-level segment vector space models with the sentence, paragraph, and document-level segment vector space models into the single vector space model.

19. The method of claim 15, wherein inputting the pre-training sequence into the natural language processing training process reduces an amount of computational processing resources used by a computer to define the syntactical elements in the set of documents.

20. The method of claim 15, wherein the natural language processing training process comprises text classification and sentiment analysis of the set of documents.
